(19) United States
(12) Patent Application Publication
(10) Pub. No.: US 2017/0042196 A1
(43) Pub. Date: Feb. 16, 2017

(54) USE OF UMAMI COMPOUNDS TO ENHANCE SALTINESS

(71) Applicant: Senomyx, Inc., San Diego, CA (US)

(72) Inventors: Stacy Markison, La Jolla, CA (US); Tanya Ditschun, San Diego, CA (US); Joseph R. Fotsing, San Diego, CA (US); Nicole Gonsalves, San Diego, CA (US); Guy Servant, San Diego, CA (US)

(21) Appl. No.: 14/823,920

(22) Filed: Aug. 11, 2015

(51) Int. Cl. A01N 25/00

(52) U.S. Cl. CPC A23L 1/22091; A23L 1/237; A23L 1/2375; A23V 2002/00

(57) ABSTRACT

Provided herein are umami compounds for use as salt-enhancing agents, and for use in enhancing the flavor of reduced sodium products or sodium-free products and increasing the palatability of products that may have reduced sodium content. Also provided herein are methods for modulating the perceived saltiness of a product by adding salt-enhancing compounds to the product.

### BACKGROUND OF THE INVENTION

Field

The present disclosure relates to the field of flavor enhancers in foods, beverages, pharmaceuticals, and other comestible compositions. More specifically, the present disclosure relates to umami compounds for use in comestible compositions for increasing the perception of saltiness in comestible products.

Background Description

The taste system provides sensory information about the chemical composition of the external world. Taste transduction is one of the most sophisticated forms of chemical-triggered sensation in animals. Signaling of taste is found throughout the animal kingdom, from simple metazoans to the most complex of vertebrates. Mammals are believed to have five basic taste modalities: sweet, bitter, sour, salty, and umami (savory taste, otherwise described as the taste of monosodium glutamate).

For centuries, various natural and unnatural compositions and/or compounds have been added to foods and beverages to improve their taste. Although it has long been known that there are only a few basic types of tastes, the biological and biochemical basis of taste perception was poorly understood, and most taste improving or taste modifying agents have been discovered largely by simple trial and error processes.

One of the five known basic tastes is the “savory” or “umami” flavor of monosodium glutamate (“MSG”), synthetic or natural versions of which are often added to foods, often at concentrations on the order of about 0.05 to about 0.5% by weight. Alternatively, MSG is present in and can be added in the form of certain food additives, such as autolyzed yeast extracts (“AYE”) or hydrolyzed vegetable proteins (“HVP”), which are often added to foods and drinks at a concentration from about 0.1 to about 2% by weight. However, MSG is known to produce adverse reactions in some people, and MSG comprises significant amounts of undesirable sodium, but very little progress has been made in identifying artificial substitutes for MSG.

Saltiness is also one of the basic taste qualities, and can easily be detected and differentiated with a variety of sensory tests. Saltiness is perceived upon tasting sodium and/or potassium chloride (NaCl/KCl). The salty taste is important to the perceived flavor intensity and profile, especially for savory food products, and in smaller concentrations also for non-savory applications, for example certain beverages, or desserts. Enhancement of saltiness is of particular interest in the flavor industry, as it improves the overall flavor of a product. However, a high amount of sodium intake is detrimental to health. For example, hypertension is a serious health problem, and excessive salt intake in the form of NaCl is believed to be an important factor in its development. In addition, a high-salt diet is a probable cause in cancers (such as stomach cancer), osteoporosis, and cardiovascular disease.

Although the U.S. Food and Drug Administration recommends limiting daily sodium intake to 2.3 grams per day, the average intake of salt by adults in the U.S. exceeds the recommended amount, and is closer to about 3.4 g/day, which is added by the consumer or by the food manufacturer to improve palatability. Unfortunately, excessive sodium intake raises blood pressure and poses health risks. An effective means for reducing sodium intake in the diet while maintaining the overall palatability of foodstuffs would have great value. To provide a salty taste to consumables, usually sodium in the form of NaCl is used. Frequently, NaCl is at least partially replaced by KCl. However, KCl is commonly characterized as having undesirable bitter and/or metallic after tastes. Other mineral salts, such as ammonium chloride and calcium chloride also impart a salty taste and can be used to replace a portion of the removed sodium but only to a limited extent because these salts impart undesirable off tastes and have different flavor profiles from that of sodium chloride.

MSG and yeast extracts have also been used in an attempt to add flavor to low-sodium or sodium-free foods. The use of MSG, however, is limited by its purported adverse health effects, such as headaches and hyperactivity. The use of yeast extracts is limited as these tend to have strong beefy flavors unsuitable for many food and beverage applications.

Therefore there is a need for reducing the sodium content in food products while concomitantly maintaining the palatability and consumer satisfaction of food products.

In addition, there is a need for providing salt-enhancing compounds that increase the salty taste at a given NaCl concentration, or alternatively that allow the reduction in the amount of NaCl in consumable products without reducing the desired taste. Although some salty flavoring ingredients have been used to replace or enhance sodium in products, (such as KCl) there remains a need in the art for new and improved flavoring agents, especially flavoring agents that are capable of fulfilling these needs by enhancing saltiness perception, while allowing a reduction in the amount of NaCl used in foods and other comestibles.

### SUMMARY

In some embodiments is provided herein a salt-enhancing compound that is capable of increasing the perception of saltiness in a comestible product, and can be used to reduce or replace the sodium content of a product. Alternatively, the salt-enhancing compound can be used in conjunction with NaCl to further enhance the saltiness of the product. In some embodiments herein, the salt-enhancing compound increases the palatability of the product.

In some embodiments provided herein, the salt-enhancing compound is a flavor modifying compound as disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, which is incorporated herein by reference in its entirety. In some embodiments, the saltiness enhancing compound is an embodiment of a flavor modifying compound as disclosed in U.S. Pat. No. 8,148,536, entitled “Comestible Compositions Comprising High Potency Savory Flavorants, and Processes for Producing Them”, issued Apr. 3, 2012, which is incorporated herein by reference in its entirety. In some embodiments, the saltiness enhancing compound is an embodiment of a flavor modifying compound as disclosed in U.S. Pat. No. 8,968,708, entitled “Compounds Comprising Linked Heteroaryl Moieties and Their Use as Novel Umami Flavor Modifiers, Tastants and Taste Enhancers for Comestible Compositions”, issued Mar. 3, 2015, which is incorporated herein by reference in its entirety.

The aforementioned references relate to umami compounds, which are used to enhance the savory sensation of products. Surprisingly, it has been found that certain of these umami enhancing compounds can be used for the enhancement of saltiness perception. Accordingly, in some embodiments disclosed herein are compositions comprising the flavor modifying compound defined by Formula (1a):

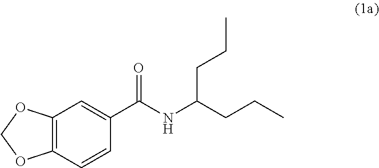 [SMILES: CCCC(CCC)NC(=O)c1ccc2c(c1)OCO2]

Some embodiments provide a comestible composition, comprising a compound having the structure of Formula (1a) or a salt or solvate thereof.

In some embodiments are compositions comprising the flavor modifying compound defined by Formula (1b):

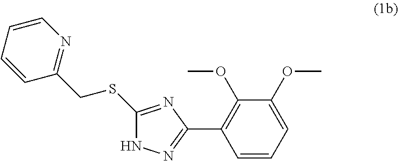 [SMILES: COc1cccc(-c2n[nH]c(SCc3ccccn3)n2)c1OC]

Some embodiments provide a comestible composition, comprising a compound having the structure of Formula (1b) or a salt or solvate thereof.

In some embodiments are compositions comprising the flavor modifying compound defined by Formula (1c):

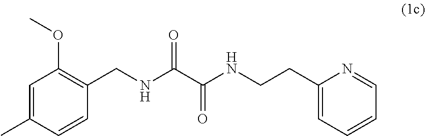 [SMILES: COc1cc(C)ccc1CNC(=O)C(=O)NCCc1ccccn1]

Some embodiments provide a comestible composition, comprising a compound having the structure of Formula (1c) or a salt or solvate thereof.

In some embodiments are compositions comprising the flavor modifying compound defined by Formula (1d):

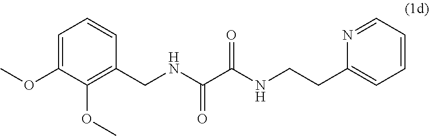 [SMILES: COc1cccc(CNC(=O)C(=O)NCCc2ccccn2)c1OC]

Some embodiments provide a comestible composition, comprising a compound having the structure of Formula (1d) or a salt or solvate thereof.

In some embodiments are compositions comprising the flavor modifying compound defined by Formula (1e):

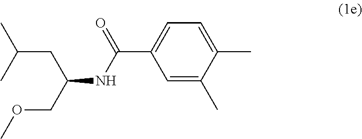 [SMILES: COC[C@@H](CC(C)C)NC(=O)c1ccc(C)c(C)c1]

Some embodiments provide an comestible composition, comprising a compound having the structure of Formula (1e) or a salt or solvate thereof.

In some embodiments are compositions comprising the flavor modifying compound defined by Formula (1f):

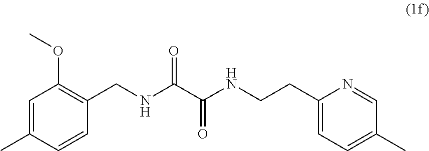

Some embodiments provide a comestible composition, comprising a compound having the structure of Formula (1f) or a salt or solvate thereof.

In some embodiments are compositions comprising the flavor modifying compound defined by Formula (1g):

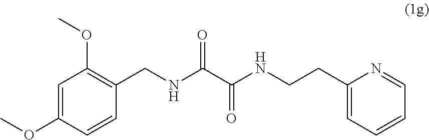 [SMILES: COc1ccc(CNC(=O)C(=O)NCCc2ccccn2)c(OC)c1]

Some embodiments provide a comestible composition, comprising a compound having the structure of Formula (1g) or a salt or solvate thereof.

The umami compounds disclosed herein do not impart undesirable characteristics as described with other salt replacers. The flavor modifying compounds defined by Formulas (1a)-(1g) are also referred to herein as salt-enhancing compounds. The compounds provided herein can be added to low sodium, reduced sodium, sodium-free, or no salt added food and beverage products to enhance the saltiness and palatability of these products, ultimately increasing consumer acceptability of such products.

In some embodiments, the flavor modifying compound that elicits an increased perception of saltiness is included in a comestible composition, such as food or beverage products, pharmaceutical products, nutritional products, dietary supplements, over-the-counter medications, or non-comestible formulations, such as oral care products, hygienic products, cleansing products, or cosmetic products.

Some embodiments provided herein include one or more compound defined by the group consisting of Formula (1a), Formula (1b), Formula (1c), Formula (1d), Formula (1e), Formula (1f), and Formula (1g), wherein the one or more compound is combined with a reduced amount of MSG, or other savory products, or a reduced amount of KCl to enhance the saltiness and palatability of consumer products.

Provided herein are methods for modulating the perceived saltiness of a comestible product, comprising providing the comestible product and mixing one or more flavor modifying compound defined by the group consisting of Formula (1a), Formula (1b), Formula (1c), Formula (1d), Formula (1e), Formula (1f), and Formula (1g) with the comestible product.

In addition to the features described above, additional features and variations will be readily apparent from the following description. It is to be understood that the following description describes typical alternatives, and is not intended to be limiting in scope. Although this invention is described in various exemplary alternatives and implementation as provided herein, it should be understood that the various features, aspects, and functionality described in one or more of the individual alternatives are not limited in their applicability to the particular alternative with which they are described. Instead, they can be applied alone or in various combinations to one or more of the other alternatives, whether the alternatives are described or whether the features are presented as being part of the described alternative. The breadth and scope of the present invention should therefore not be limited by any exemplary alternatives described herein.

### DETAILED DESCRIPTION

Embodiments disclosed herein relate generally to formulations and compositions comprising a flavor modifying compound that elicits a perception of saltiness. In some embodiments, these formulations and compositions comprise compounds that are capable replacing or reducing the content of NaCl in comestible product formulations. The formulations and compositions can be used in a variety of comestible or non-comestible compositions. In some embodiments, the comestible composition comprises a flavor modifying compound that elicits a perception of saltiness. The present invention also relates to compositions that are capable of improving the tastes of low sodium or no sodium products by imparting a more salt-like taste or characteristic, thereby improving the palatability of low sodium or no sodium products.

In some embodiments, the comestible composition can be food or beverage products.

In some embodiments, the beverage can be selected from broths, cocktails, including, for example, Bloody Mary, enhanced sparkling beverages, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea-type drinks, coffees, cocoa drinks, beverages containing milk components, beverages containing cereal extracts, and smoothies.

In some embodiments, the comestible composition can be pharmaceutical products, nutritional products, dietary supplements, or over-the-counter medications. In some embodiments, the non-comestible composition can be oral care products, hygienic or cosmetic products.

These and other embodiments, advantages, and features of the present invention are provided in part in the description that follows, and in part will be obvious from the description, or may be learned by practice of the invention. It is to be understood that both the foregoing general description and the following detailed description are exemplary and explanatory only and are not restrictive of the invention as described. Unless defined otherwise, all technical and scientific terms used herein have the same meaning as commonly understood by one of ordinary skill in the art to which this invention belongs.

### Definitions

Unless defined otherwise, all technical and scientific terms used herein have the same meaning as is commonly understood by one of ordinary skill in the art to which this disclosure belongs. All patents, applications, published applications, and other publications are incorporated by reference in their entirety. In the event that there is a plurality of definitions for a term herein, those in this section prevail unless stated otherwise.

The terms “a” and “an” do not denote a limitation of quantity, but rather denote the presence of at least one of the referenced item. The term “or” or “and/or” is used as a function word to indicate that two words or expressions are to be taken together or individually. The terms “comprising”, “having”, “including”, and “containing” are to be construed as open-ended terms (i.e., meaning “including, but not limited to”). The endpoints of all ranges directed to the same component or property are inclusive and independently combinable.

“Saltiness” refers the perception of the salty flavor of a product, such as a food or beverage product. Saltiness is a taste produced by the presence of sodium, and table salt is made up of sodium chloride (NaCl). When referring specifically to NaCl, the term sodium chloride, NaCl, or table salt will be used. Many products incorporate NaCl to enhance the perception of saltiness. Comestible products are often labelled as “reduced sodium”, “low sodium”, “no salt added”, or “sodium-free.” Such products have reduced levels of NaCl, and as a result, the perception of saltiness may be reduced.

Although this disclosure relates to compounds that are used to enhance or modify the perception of saltiness, the term “salt” as used herein refers to a salt of a compound, and not to NaCl. Salts possess the desired activity of the parent compound. Such salts include: (1) acid addition salts, formed with inorganic acids such as hydrochloric acid, hydrobromic acid, sulfuric acid, nitric acid, phosphoric acid, and the like; or formed with organic acids such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl) benzoic acid, cinnamic acid, mandelic acid, methanesulfonic acid, ethanesulfonic acid, 1,2-ethane-disulfonic acid, 2-hydroxyethanesulfonic acid, benzenesulfonic acid, 4-chlorobenzenesulfonic acid, 2-naphthalenesulfonic acid, 4-toluenesulfonic acid, camphorsulfonic acid, 4-methylbicyclo[2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid, and the like; or (2) salts formed when an acidic proton present in the parent compound is replaced by a metal ion, e.g., an alkali metal ion, an alkaline earth ion, or an aluminum ion; or coordinates with an organic base such as ethanolamine, diethanolamine, triethanolamine, N-methylglucamine and the like.

“Solvate” means a compound formed by solvation (the combination of solvent molecules with molecules or ions of the solute), or an aggregate that consists of a solute ion or molecule, i.e., a compound described herein, with one or more solvent molecules. When water is the solvent, the corresponding solvate is “hydrate”.

“Vehicle” refers to a diluent, adjuvant, excipient or carrier with which a compound is combined.

As used herein, an “comestible composition” includes any substance that, either alone or together with another substance, can be taken by mouth whether intended for consumption or not. The comestible composition includes both “food or beverage products” and “non-edible products”. By “Food or beverage products”, it is meant any edible product intended for consumption by humans or animals, including solids, semi-solids, or liquids (e.g., beverages). Comestible compositions can also include supplements, nutraceuticals, functional food products (e.g., any fresh or processed food claimed to have a health-promoting and/or disease-preventing properties beyond the basic nutritional function of supplying nutrients), pharmaceutical and over the counter medications. The term “non-edible products” includes any product or composition that can be taken into the mouth by humans or animals for purposes other than consumption. For example, the non-edible product includes oral care products such as dentifrices and mouthwashes, cosmetic products such as lip balms and other personal care products that may or may not contain any saltiness enhancing compounds.

An “ingestibly acceptable carrier or excipient” is a medium and/or composition that is used to prepare a desired dispersed dosage form of the inventive compound, in order to administer the inventive compound in a dispersed/diluted form, so that the biological effectiveness of the inventive compound is maximized. The medium and/or composition may be in any form depending on the intended use of a product, e.g., solid, semi-solid, liquid, paste, gel, lotion, cream, foamy material, suspension, solution, or any combinations thereof (such as a liquid containing solid contents). Ingestibly acceptable carriers includes many common food ingredients, such as water at neutral, acidic, or basic pH, fruit or vegetable juices, vinegar, soy based sauces, marinades, beer, wine, natural water/fat emulsions such as milk or condensed milk, edible oils and shortenings, fatty acids and their alkyl esters, low molecular weight oligomers of propylene glycol, glyceryl esters of fatty acids, and dispersions or emulsions of such hydrophobic substances in aqueous media, salts such as sodium chloride, wheat flours, solvents such as ethanol, solid edible diluents such as vegetable powders or flours, or other liquid vehicles; dispersion or suspension aids; surface active agents; isotonic agents; thickening or emulsifying agents, preservatives; solid binders; lubricants and the like.

A “saltiness enhancing compound”, “salt-enhancing compound”, or “salt enhancer”, herein refers to a compound or ingestibly acceptable salt thereof that elicits a detectable salty flavor in a subject.

A “flavor modifying compound” or “flavor modifier” or “flavor modifying agent” herein refers to a compound or the ingestibly acceptable salt or solvate thereof that modulates, including enhancing or potentiating, and/or inducing, the tastes of a flavoring agent in an animal or a human. An example of a flavor modifying compounds is a salt-enhancing compound.

A “flavoring agent” herein refers to a compound or the ingestibly acceptable salt or solvate thereof that induces a flavor or taste in an animal or a human. The flavoring agent can be natural, semi-synthetic, or synthetic.

A “flavor enhancer” herein refers to a compound or ingestibly acceptable salt thereof that enhances and/or multiplies the tastes of a flavoring agent, or a comestible composition comprising the flavoring agent.

An “enhancer” herein refers to a compound, or an ingestibly acceptable salt or solvate thereof, that modulates (increases) a flavor (e.g., saltiness) or the activation of a particular receptor, preferably the chemosensory receptor.

A “flavor” herein refers to the perception of taste in a subject, which include sweet, sour, salty, bitter and umami. The subject may be a human or an animal.

A “salty flavor modifier” or “salty flavor modifying agent” herein refers to a compound or ingestibly acceptable salt or solvate thereof that modulates, including enhancing or potentiating, inducing, or blocking, the salty taste of a salty flavoring agents in an animal or a human. The salty flavor modifier includes both salty flavor enhancer and salty flavoring agent.

A “salty flavor enhancer” or “salty flavor enhancing agent” herein refers to an enhancer of a salty flavor wherein the term enhancer is the same as defined above.

A “salty flavor modulating amount” herein refers to an amount of salty flavor modifier that is sufficient to alter (either increase or decrease) salty taste in a comestible composition, or a precursor thereof, sufficiently to be perceived by a human subject. In many embodiments, at least about 0.001 ppm of the present compound would need to be present in order for most human subjects to perceive a modulation of the salty flavor of a comestible composition comprising the present compound. A broad range of concentration that would typically be employed in order to economically provide a desirable degree of salty flavor modulation can be from about 0.001 ppm to 10,000 ppm, or a narrow range from about 0.1 ppm to about 1,000 ppm. Alternative ranges of salty flavor modulating amounts can be from about 0.01 ppm to about 3,000 ppm, from about 0.05 ppm to about 1,500 ppm, from about 0.1 ppm to about 500 ppm, from about 0.1 ppm to about 300 ppm, from about 0.1 to about 50 ppm, from about 0.1 to about 10 ppm, from about 0.1 to about 2 ppm or a concentration that is within range defined by any of the two aforementioned concentrations.

A “salty flavor enhancing amount” herein refers to an amount of a compound that is sufficient to enhance the taste of flavoring agents in a comestible composition, as perceived by an animal or a human. A broad range of a salty flavor enhancing amount can be from about 0.001 ppm to 100 ppm, or a narrow range from about 0.1 ppm to about 10 ppm. Alternative ranges of salty flavor enhancing amounts can be from about 0.01 ppm to about 30 ppm, from about 0.05 ppm to about 15 ppm, from about 0.1 ppm to about 5 ppm, or from about 0.1 ppm to about 3 ppm. In some embodiments, salty flavor enhancing amount is the amount corresponding to ligand enhancing concentration(s) of a salty flavor enhancer of the present invention.

The “salt-like” characteristics of the compounds of the present invention include any characteristic similar to that of NaCl and include, but are not limited to, maximal response, flavor profile, temporal profile, adaptation behavior, mouthfeel, concentration/response function, tastant/and flavor/salty taste interactions, spatial pattern selectivity, and temperature effects. Of these, the flavor profile and temporal profile are particularly important.

“Low sodium,” when used herein to refer to a comestible composition, means the composition has 140 mg sodium or less per serving of the composition. “Reduced sodium,” when used herein to refer to a comestible composition, means the composition has at least 25% less sodium per serving than a similar comestible composition in which no effort has been made to reduce the sodium level. Exemplary amounts of sodium in a single serving of certain foods in which no effort has been made to reduce the sodium level include: 890 mg in canned soup; 860 mg in chicken broth; 460 mg in Bloody Mary; 306 mg in white bread; and 150 mg in saltine crackers. “Sodium-free,” when used herein to refer to a comestible composition, means the composition has less than 5 mg of sodium per serving. In some embodiments, sodium-free compositions have substantially no sodium. The content of sodium may be from any source, including sodium chloride. “No salt added,” as used herein, means that no sodium chloride is added during preparation of a comestible composition.

### Saltiness Enhancing Compounds

Surprisingly, it was found that the compounds provided herein enhance the saltiness of the foodstuffs. Such compounds are salty flavor enhancers, and are described herein.

Accordingly, in some embodiments disclosed herein are compositions comprising the flavor modifying compound defined by Formula (1a):

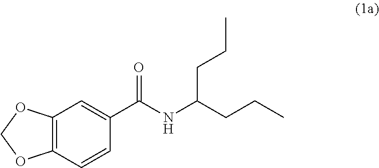 [SMILES: CCCC(CCC)NC(=O)c1ccc2c(c1)OCO2]

The synthesis of the compound defined by Formula (1a) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, and U.S. Pat. No. 8,148,536, entitled “Comestible Compositions Comprising High Potency Savory Flavorants, and Processes for Producing Them”, issued Apr. 3, 2012, the disclosures of which are incorporated herein by reference in their entirety.

In some embodiments are compositions comprising the flavor modifying compound defined by Formula (1b):

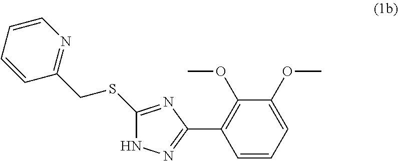 [SMILES: COc1cccc(-c2n[nH]c(SCc3ccccn3)n2)c1OC]

The synthesis of the compound defined by Formula (1b) is disclosed in U.S. Pat. No. 8,968,708, entitled “Compounds Comprising Linked Heteroaryl Moieties and Their Use as Novel Umami Flavor Modifiers, Tastants and Taste Enhancers for Comestible Compositions”, issued Mar. 3, 2015, the disclosure of which is incorporated herein by reference in its entirety.

In some embodiments are compositions comprising the flavor modifying compound defined by Formula (1c):

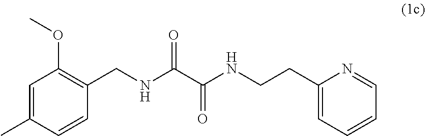 [SMILES: COc1cc(C)ccc1CNC(=O)C(=O)NCCc1ccccn1]

The synthesis of the compound defined by Formula (1c) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, and U.S. Pat. No. 8,148,536, entitled “Comestible Compositions Comprising High Potency Savory Flavorants, and Processes for Producing Them”, issued Apr. 3, 2012, the disclosures of which are incorporated herein by reference in their entirety.

In some embodiments are compositions comprising the flavor modifying compound defined by Formula (1d):

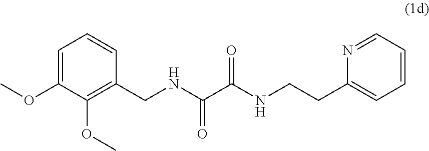 [SMILES: COc1cccc(CNC(=O)C(=O)NCCc2ccccn2)c1OC]

The synthesis of the compound defined by Formula (1d) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, the disclosure of which is incorporated herein by reference in its entirety.

In some embodiments are compositions comprising the flavor modifying compound defined by Formula (1e):

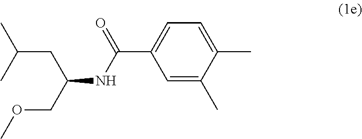 [SMILES: COC[C@@H](CC(C)C)NC(=O)c1ccc(C)c(C)c1]

The synthesis of the compound defined by Formula (le) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, the disclosure of which is incorporated herein by reference in its entirety.

In some embodiments are compositions comprising the flavor modifying compound defined by Formula (1f):

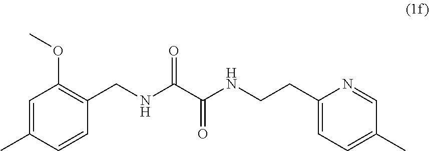

The synthesis of the compound defined by Formula (1f) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, and U.S. Pat. No. 8,148,536, entitled “Comestible Compositions Comprising High Potency Savory Flavorants, and Processes for Producing Them”, issued Apr. 3, 2012, the disclosures of which are incorporated herein by reference in their entirety.

In some embodiments are compositions comprising the flavor modifying compound defined by Formula (1g):

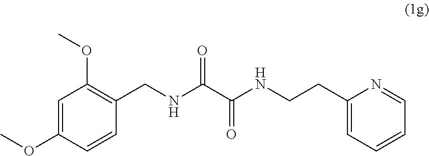 [SMILES: COc1ccc(CNC(=O)C(=O)NCCc2ccccn2)c(OC)c1]

The synthesis of the compound defined by Formula (1g) is disclosed in U.S. Pat. No. 7,476,399, entitled “Flavors, Flavor Modifiers, Tastants, Taste Enhancers, Umami or Sweet Tastants, and/or Enhancers and Use Thereof”, issued Jan. 13, 2009, and U.S. Pat. No. 8,148,536, entitled “Comestible Compositions Comprising High Potency Savory Flavorants, and Processes for Producing Them”, issued Apr. 3, 2012, the disclosures of which are incorporated herein by reference in their entirety.

### Compositions and Uses

Some compositions herein relate to formulations comprising one or more salt-enhancing compounds as disclosed herein for enhancing the perception of saltiness in comestible formulations. It is recognized that the formulations comprising salt-enhancing compounds as disclosed herein are non-limiting. In some embodiments, said formulations comprising one or more salt-enhancing compounds are used as compositions for comestible or non-comestible products, wherein the products may be identified as any of normal sodium levels, low sodium, reduced sodium, sodium-free, or no salt added.

In some embodiments, the present formulations have NaCl modifying behavior and/or salty agonist behavior in vitro and/or in vivo (e.g., as shown in sensory studies). In some embodiments, the present formulations demonstrate a favorable side-taste profile in vivo.

Whether or not a formulation exhibits salty modifying/agonist effects can be determined by any suitable test method. For example, the formulation comprising one or more salt-enhancing compounds can be evaluated in a sensory test using a human taste panel.

In some embodiments, the formulation may be diluted before being tested. In some embodiments, the formulation is diluted for about 2, about 5, about 10, about 50, about 100, about 200, about 300, about 400, about 500, about 1000, or more times before being tested.

The tests can be conducted with and/or without additives. In some embodiments, the formulation is tested as a saltiness enhancer to one or more additives. In the test, the participants can provide their impression as to the similarities of the characteristics of the salty compositions, with and/or without additives, with those comprising NaCl. A suitable procedure for determining whether a composition has a more salt-like taste is through the use of a panel of assessors, who measure the saltiness of the formulations.

One embodiment provides a formulation for use in a method of preparing a ready-to-use composition, such as a final food or beverage product. The method comprises contacting a first composition, such as a first food or beverage product that may contain NaCl, with one or more salt-enhancement formulation (e.g., solid or liquid) comprising a compound having structural Formula (1a), Formula (1b), Formula (1c), Formula (1d), Formula (1e), Formula (1f) or Formula (1g) or combinations thereof to form the ready-to-use composition.

In some embodiments, a comestible composition may be a beverage. In some embodiments, the beverage may be selected from the group consisting of broths, cocktail mixes, including, for example, Bloody Mary, enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink. In some embodiments, the beverage may be low sodium, reduced sodium, sodium-free, or no salt added.

Some embodiments provide supplements, nutraceuticals, functional food products (e.g., any fresh or processed food claimed to have a health-promoting and/or disease-preventing properties beyond the basic nutritional function of supplying nutrients), pharmaceutical product, over the counter (OTC) product, oral care product, cosmetic products such as lip balms, and other personal care products including one or more salt-enhancing compounds as described herein.

In general, over the counter (OTC) product and oral care product generally refer to product for household and/or personal use which may be sold without a prescription and/or without a visit to a medical professional. Examples of the OTC products include, but are not limited to Vitamins and dietary supplements; Topical analgesics and/or anesthetic; Cough, cold and allergy remedies; Antihistamines and/or allergy remedies; and combinations thereof. Vitamins and dietary supplements include, but are not limited to vitamins, dietary supplements, tonics/bottled nutritive drinks, child-specific vitamins, dietary supplements, any other products of or relating to or providing nutrition, and combinations thereof. Topical analgesics and/or anesthetic include any topical creams/ointments/gels used to alleviate superficial or deep-seated aches and pains, e.g. muscle pain; teething gel; patches with analgesic ingredient; and combinations thereof. Cough, cold and allergy remedies include, but are not limited to decongestants, cough remedies, pharyngeal preparations, medicated confectionery, antihistamines and child-specific cough, cold and allergy remedies; and combination products. Antihistamines and/or allergy remedies include, but are not limited to any systemic treatments for hay fever, nasal allergies, insect bites and stings. Examples of oral care product include, but are not limited to mouth cleaning strips, toothpaste, toothbrushes, mouthwashes/dental rinses, denture care, mouth fresheners at-home teeth whiteners, dentifrices, and dental floss.

In some embodiments, one or more salt-enhancing compounds may be included in food or beverage products or formulations. Examples of food and beverage products or formulations include, but are not limited to any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, fat compositions, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups). In some embodiments, any one of the above may be low sodium, reduced sodium, sodium-free, or no salt added.

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen. In some embodiments, any one of the above may be low sodium, reduced sodium, sodium-free, or no salt added.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to cocktail mixes, including for example, Bloody Mary, beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water. In some embodiments, any one of the above may be low sodium, reduced sodium, sodium-free, or no salt added.

The Snack Food category generally refers to any food that can be a light informal meal including, but not limited to sweet and savory snacks and snack bars. Examples of snack food include, but are not limited to fruit snacks, chips/crisps, extruded and pellet snacks, tortilla/corn chips, popcorn, pretzels, nuts and other sweet and savory snacks. Examples of snack bars include, but are not limited to granola/muesli bars, breakfast bars, energy bars, fruit bars, rice cakes, rice snacks, and other snack bars. In some embodiments, any one of the above may be low sodium, reduced sodium, sodium-free, or no salt added.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof. In some embodiments, any one of the above may be low sodium, reduced sodium, sodium-free, or no salt added.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams. In some embodiments, any one of the above may be low sodium, reduced sodium, sodium-free, or no salt added.

The Confectionery category generally refers to edible product that is sweet to the taste. Examples of confectionery include, but are not limited to candies, gelatins, chocolate confectionery, sugar confectionery, gum, and the likes and any combination products. In some embodiments, any one of the above may be low sodium, reduced sodium, sodium-free, or no salt added.

The Meal Replacement category generally refers to any food intended to replace the normal meals, particularly for people having health or fitness concerns. Examples of meal replacement include, but are not limited to slimming products and convalescence products. In some embodiments, any one of the above may be low sodium, reduced sodium, sodium-free, or no salt added.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads. In some embodiments, any one of the above may be low sodium, reduced sodium, sodium-free, or no salt added.

The Pasta and Noodle category includes any pastas and/or noodles including, but not limited to canned, dried and chilled/fresh pasta; and plain, instant, chilled, frozen and snack noodles. In some embodiments, any one of the above may be low sodium, reduced sodium, sodium-free, or no salt added.

The Canned/Preserved Food category includes, but is not limited to dried canned/preserved meat and meat products, fish/seafood, vegetables, tomatoes, beans, fruit, ready meals, soup, pasta, and other canned/preserved foods. In some embodiments, any one of the above may be low sodium, reduced sodium, sodium-free, or no salt added.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food. In some embodiments, any one of the above may be low sodium, reduced sodium, sodium-free, or no salt added.

The Dried Processed Food category includes, but is not limited to rice, dessert mixes, dried ready meals, dehydrated soup, instant soup, dried pasta, plain noodles, and instant noodles. In some embodiments, any one of the above may be low sodium, reduced sodium, sodium-free, or no salt added.

The Chill Processed Food category includes, but is not limited to chilled processed meats, processed fish/seafood products, lunch kits, fresh cut fruits, ready meals, pizza, prepared salads, soup, fresh pasta and noodles. In some embodiments, any one of the above may be low sodium, reduced sodium, sodium-free, or no salt added.

The Sauces, Dressings and Condiments category includes, but is not limited to tomato pastes and purees, bouillon/stock cubes, herbs and spices, monosodium glutamate (MSG), table sauces, soy based sauces, fish sauce, pasta sauces, wet/cooking sauces, dry sauces/powder mixes, ketchup, mayonnaise, mustard, salad dressings, salad toppings, liquid recipe mixes, vinaigrettes, dips, pickled products, breading, batter mix, shelf-stable spreads, and other sauces, dressings and condiments. In some embodiments, any one of the above may be low sodium, reduced sodium, sodium-free, or no salt added.

The Baby Food category includes, but is not limited to milk- or soybean-based formula; and prepared, dried and other baby food. In some embodiments, any one of the above may be low sodium, reduced sodium, sodium-free, or no salt added.

The Spreads category includes, but is not limited to jams and preserves, honey, chocolate spreads, nut based spreads, and yeast based spreads. In some embodiments, any one of the above may be low sodium, reduced sodium, sodium-free, or no salt added.

The Dairy Product category generally refers to edible product produced from mammal's milk. Examples of dairy product include, but are not limited to drinking milk products, cheese, yoghurt and sour milk drinks, and other dairy products. In some embodiments, any one of the above may be low sodium, reduced sodium, sodium-free, or no salt added.

Additional examples for comestible compositions, particularly food and beverage products or formulations, are provided as follows. Exemplary comestible compositions include one or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, ready-to-eat (RTE) cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/UHT milk, full fat long life/UHT milk, semi skimmed long life/UHT milk, fat-free long life/UHT milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded and pellet snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned and dried meat and meat products, canned and dried fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, liquid recipe mixes, dressings and condiments, tomato pastes and purees, bouillon/stock cubes, stock cubes, gravy granules, liquid stocks and fonds, herbs and spices, breading, batter mix, fermented sauces, soy based sauces, pasta sauces, wet sauces, dry sauces/powder mixes, ketchup, mayonnaise, regular mayonnaise, mustard, salad dressings, salad toppings, regular salad dressings, low fat salad dressings, vinaigrettes, dips, pickled products, shelf stable spreads, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary comestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, fat compositions, baby foods, or spreads or a mixture thereof. Exemplary comestible compositions also include breakfast cereals, sweet or savory beverages or solid or liquid concentrate compositions for preparing beverages, ideally so as to enable the reduction in concentration of sodium chloride. In some embodiments, any one of the above may be low sodium, reduced sodium, sodium-free, or no salt added.

In some embodiments, the one or more salt-enhancing compound is added to a comestible formulation, such as a food or beverage, wherein the comestible formulation contains normal sodium concentrations. For example, the one or more salt-enhancing compound can be added to a soup having around 800 mg or more of sodium per serving. Alternatively, the one or more salt-enhancing compounds can be added to: broth having about 800 mg or more of sodium per serving; bakery products such as breads or desserts having about 400 mg or more of sodium per serving; or beverages having about 400 mg or more of sodium per serving. The salt-enhancing compounds can be added to any formulation having normal sodium levels to enhance the sodium flavor thereof.

In some embodiments, the one or more salt-enhancing compound is added to a comestible formulation, such as a food or beverage, wherein the comestible formulation is a low sodium, reduced sodium, sodium-free, or no salt added formulation. Thus, one or more salt-enhancing compounds can be added to a formulation having less than about 140 mg of sodium per serving. In some embodiments, the one or more salt-enhancing compounds can be added to a formulation having about 25% or less sodium than a similar formulation in which no effort has been made to reduce the sodium level. In some embodiments, the one or more salt-enhancing compounds can be added to a formulation having less than about 5 mg of sodium per serving. The one or more salt-enhancing compounds is used to enhance the perception of saltiness in the formulations that are low sodium, reduced sodium, sodium-free, or no salt added. In addition, the one or more compounds can be added to a formulation that is low sodium, reduced sodium, sodium-free, or no salt added that also is low in typical sodium chloride replacement salts, such as, for example potassium chloride, ammonium chloride, and calcium chloride, wherein the amount of potassium chloride, ammonium chloride, or calcium chloride is less than 140 mg per serving. In various embodiments, the concentration of sodium in the formulation is less than about 2 wt. %, less than about 1.8 wt. %, less than about 1.6 wt. %, less than about 1.4 wt. %, less than about 1.2 wt. %, less than about 1 wt. %, less than about 0.8 wt. %, less than about 0.6 wt. %, less than about 0.4 wt. %, less than about 0.2 wt. %, less than about 0.1 wt. %, less than about 0.08 wt. %, less than about 0.06 wt. %, less than about 0.04 wt. %, or less than about 0.02 wt. %.

In some embodiments, the comestible formulations comprise one or more salt-enhancing compounds described herein, wherein the amount of chloride salts in the formulation, such as sodium chloride, potassium chloride, ammonium chloride, or calcium chloride or combinations thereof, is less than about 900 mg, 600 mg, 400 mg, 140 mg, or 5 mg per serving, or an amount that is within a range defined by any two of the aforementioned values. In some embodiments, there are substantially no chloride salts in the formulation. In some embodiments, the concentration of chloride salts in the formulation (such as sodium chloride, potassium chloride, ammonium chloride, or calcium chloride or combinations thereof) is less than about 5 wt. %, less than about 4.5 wt. %, less than about 4 wt. %, less than about 3.5 wt. %, less than about 3 wt. %, less than about 2.6 wt. %, less than about wt. %, less than about 2.4 wt. %, less than about 2.2 wt. %, less than about 2 wt. %, less than about 1.8 wt. %, less than about 1.6 wt. %, less than about 1.4 wt. %, less than about 1.2 wt. %, less than about 1 wt. %, less than about 0.8 wt. %, less than about 0.6 wt. %, less than about 0.5 wt. %, less than about 0.4 wt. %, less than about 0.3 wt. %, less than about 0.2 wt. %, less than about 0.1 wt. %, less than about 0.08 wt. %, less than about 0.06 wt. %, less than about 0.04 wt. %, or less than about 0.02 wt. %.

In various embodiments, the comestible formulations comprise one or more salt-enhancing compounds described herein, wherein the concentration of monosodium glutamate is less than about 1.5 wt. %, less than about 1.3 wt. %, less than about 1.2 wt. %, less than about 1 wt. %, less than about 0.9 wt. %, less than about 0.8 wt. %, less than about 0.7 wt. %, less than about 0.6 wt. %, less than about 0.5 wt. %, less than about 0.4 wt. %, less than about 0.3 wt. %, less than about 0.2 wt. %, less than about 0.1 wt. %, less than about 0.09 wt. %, less than about 0.08 wt. %, less than about 0.07 wt. %, less than about 0.06 wt. %, less than about 0.05 wt. %, less than about 0.02 wt. %, or less than about 0.01 wt. %.

Some embodiments provide a chewable composition that may or may not be intended to be swallowed. In some embodiments, the chewable composition may be gum, chewing gum, sugarized gum, sugar-free gum, functional gum, bubble gum including a flavor modifying compound as described herein and sweetener as described herein. In some embodiments, any one of the above may be low sodium, reduced sodium, sodium-free, or no salt added.

In some embodiments, one or more salt-enhancing compounds as described herein may be provided in a flavoring concentrate formulation, e.g., suitable for subsequent processing to produce a ready-to-use (i.e., ready-to-serve) product. By “a flavoring concentrate formulation”, it is meant a formulation which should be reconstituted with one or more diluting medium to become a ready-to-use composition. The term “ready-to-use composition” is used herein interchangeably with “comestible composition”, which denotes any substance that, either alone or together with another substance, can be taken by mouth whether intended for consumption or not. In one embodiment, the ready-to-use composition includes a composition that can be directly consumed by a human or animal. The flavoring concentrate formulation is typically used by mixing with or diluted by one or more diluting medium, e.g., any consumable or comestible ingredient or product, to impart or modify one or more flavors to the diluting medium. Such a use process is often referred to as reconstitution. The reconstitution can be conducted in a household setting or an industrial setting. For example, a frozen fruit juice concentrate can be reconstituted with water or other aqueous medium by a consumer in a kitchen to obtain the ready-to-use fruit juice beverage. In another example, a soft drink syrup concentrate can be reconstituted with water or other aqueous medium by a manufacturer in large industrial scales to produce the ready-to-use soft drinks. Since the flavoring concentrate formulation has the flavoring agent or flavor modifying agent in a concentration higher than the ready-to-use composition, the flavoring concentrate formulation is typically not suitable for being consumed directly without reconstitution. There are many benefits of using and producing a flavoring concentrate formulation. For example, one benefit is the reduction in weight and volume for transportation as the flavoring concentrate formulation can be reconstituted at the time of usage by the addition of suitable solvent, solid or liquid.

In one embodiment, the flavoring concentrate formulation comprises i) one or more salt-enhancing compounds as described herein; ii) a carrier; and iii) optionally at least one adjuvant. The term “carrier” denotes a usually inactive accessory substance, such as solvents, binders, or other inert medium, which is used in combination with the flavor modifying compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more salt-enhancing compounds. The one or more salt-enhancing compounds can be any of the compounds described above or combinations thereof. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In one embodiment, the present flavoring concentrate formulation can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavoring concentrate formulation may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavoring concentrate formulation is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

In one embodiment, the flavoring concentrate formulation comprises the one or more salt-enhancing compounds in a concentration that is at least 2 times of the concentration of the compound in a ready-to-use composition. In one embodiment, the flavoring concentrate formulation comprises the one or more salt-enhancing compounds in a concentration that is at least 5 times of the concentration of the compound in a ready-to-use composition. In one embodiment, the flavoring concentrate formulation comprises the one or more salt-enhancing compounds in a concentration that is at least 10 times of the concentration of the compound in a ready-to-use composition. In one embodiment, the flavoring concentrate formulation comprises the one or more salt-enhancing compounds in a concentration that is at least 15 times of the concentration of the compound in a ready-to-use composition. In one embodiment, the flavoring concentrate formulation comprises the one or more salt-enhancing compounds in a concentration that is at least 20 times of the concentration of the compound in a ready-to-use composition. In one embodiment, the flavoring concentrate formulation comprises the one or more salt-enhancing compounds in a concentration that is at least 30 times of the concentration of the compound in a ready-to-use composition. In one embodiment, the flavoring concentrate formulation comprises the one or more salt-enhancing compounds in a concentration that is at least 40 times of the concentration of the compound in a ready-to-use composition. In one embodiment, the flavoring concentrate formulation comprises the one or more salt-enhancing compounds in a concentration that is at least 50 times of the concentration of the compound in a ready-to-use composition. In one embodiment, the flavoring concentrate formulation comprises the one or more salt-enhancing compounds in a concentration that is at least 60 times of the concentration of the compound in a ready-to-use composition. In one embodiment, the flavoring concentrate formulation comprises the one or more salt-enhancing compounds in a concentration that is up to 100 times of the concentration of the compound in a ready-to-use composition.

In addition to the above formulations is provided a method of modulating the perception of saltiness in a formulation. Saltiness perception is modulated by providing a comestible composition, which can be of any type provided herein or of all varieties. One or more salt-enhancing compound as provided herein is mixed with the comestible composition, thereby providing a formulation comprising the comestible composition with the one or more salt-enhancing compound. The one or more salt-enhancing compound can be added in amounts sufficient to modulate the perception of saltiness to any degree required. For example, the amount of the one or more salt-enhancing compounds may vary depending on whether the comestible composition is high or low in sodium, or whether the desire is to create a high perception of saltiness or a more subtle perception of saltiness. Embodiments provided herein also include methods of modulating the perception of saltiness in a formulation, wherein the one or more salt-enhancing compound is thoroughly mixed throughout the comestible composition. Alternatively, the one or more salt-enhancing compound is lightly mixed, or only coated on the comestible composition, depending on the specific composition and application thereof.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

Three types of tests were performed with various umami compounds as described herein. The examples below provide results for the tests performed with the umami compounds, which show the surprising results of the effectiveness of the umami compounds for enhancing the perception of saltiness in comestible products.

The compounds used in the examples below are provided in Table 1.

TABLE 1

| For- | |
|---|---|
| mula | Structure |
| 1a | 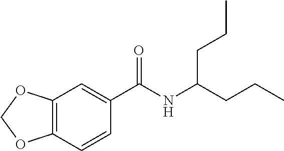 [SMILES: CCCC(CCC)NC(=O)c1ccc2c(c1)OCO2] |
| 1b | 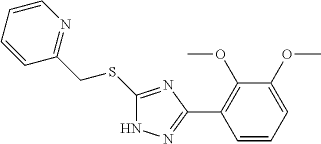 [SMILES: COc1cccc(-c2n[nH]c(SCc3ccccn3)n2)c1OC] |
| 1c | 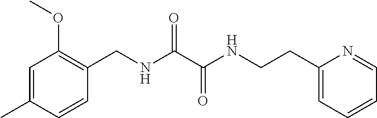 [SMILES: COc1cc(C)ccc1CNC(=O)C(=O)NCCc1ccccn1] |
| 1d | 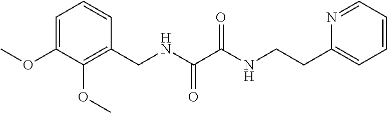 [SMILES: COc1cccc(CNC(=O)C(=O)NCCc2ccccn2)c1OC] |
| 1e | 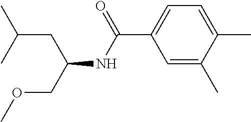 [SMILES: COC[C@@H](CC(C)C)NC(=O)c1ccc(C)c(C)c1] |
| 1f | 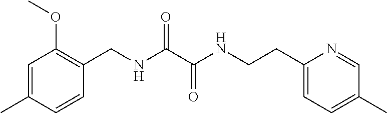 |
| 1g | 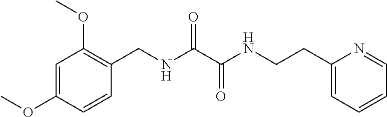 [SMILES: COc1ccc(CNC(=O)C(=O)NCCc2ccccn2)c(OC)c1] |

### Example 1

### Enhancement of Saltiness Perception in Low Sodium Chicken Broth Using a 2-Alternative Forced Choice Test

Samples of low sodium chicken broth were prepared and compared using human taste tests. Control samples contained low sodium chicken broth alone. Test samples contained the same low sodium chicken broth to which a specific umami compound was added at a specified concentration. To prepare the test sample, a concentrated stock solution of an umami compound was prepared in ethanol. The stock solution was added to a commercially available no-MSG added, low sodium chicken broth (Pacific Organic Free Range Chicken Broth Low Sodium), resulting in a final concentration of the umami compound in the test sample with 0.1% ethanol. To create the control sample, the chicken broth was balanced with 0.1% ethanol. All samples were served at 55° C.

Trained panelists were used to complete the test with three replicates (subject number reported in each table). A 2-Alternative Forced Choice test was used, where panelists received two three-digit blind-coded samples, one control and one test sample, in randomized, counter-balanced order. Panelists tasted samples, rinsing with water between samples, and indicated which of the two samples was saltier. The results were analyzed using a binomial distribution with alpha=0.1.

### Example 1a

### Formula (1a) in Low Sodium Chicken Broth using 2-Alternative Forced Choice

A concentrated stock solution of 4000 ppm of Formula (la) was prepared in ethanol. The stock solution was added to the low sodium chicken broth to a final concentration of 2 ppm, and 0.05% ethanol. The control sample was balanced with 0.05% ethanol.

TABLE 2
Formula (1a) in low sodium chicken broth. Sample selected as saltier
by panelists, n = 48 (16 panelists × 3 replicates).

| Samples | Total |
|---|---|
| Low Sodium Chicken Broth | 13 |
| Low Sodium Chicken Broth + | 35 |
| 2 ppm Formula (1a) | |
| Total | 48 |
| Low Sodium Chicken Broth + | 0.002 |
| 2 ppm Formula (1a) selected (p-value) | |

A statistically significant difference was found between the samples; panelists indicated that the test sample containing 2 ppm Formula (la) was significantly saltier than the control sample (p<0.1).

### Example 1b

### Formula (1b) in Low Sodium Chicken Broth using 2-Alternative Forced Choice

A concentrated stock solution of 5000 ppm of Formula (1b) was prepared in ethanol. The stock solution was added to the low sodium chicken broth to a final concentration of 5 ppm, and 0.1% ethanol. The control sample was balanced with 0.1% ethanol.

TABLE 3
Formula (1b) in low sodium chicken broth. Sample selected as saltier
by panelists, n = 48 (16 panelists × 3 replicates).

| Samples | Total |
|---|---|
| Low Sodium Chicken Broth | 15 |
| Low Sodium Chicken Broth + | 33 |
| 5 ppm Formula (1b) | |
| Total | 48 |
| Low Sodium Chicken Broth + | 0.013 |
| 5 ppm Formula (1b) selected (p-value) | |

A statistically significant difference was found between the samples; panelists indicated that the test sample containing 5 ppm Formula (1b) was significantly saltier than the control sample (p<0.1).

### Example 1c

### Formula (1c) in Low Sodium Chicken Broth using 2-Alternative Forced Choice

A concentrated stock solution of 1000 ppm of Formula (1c) was prepared in ethanol. The stock solution was added to the low sodium chicken broth to a final concentration of 1 ppm, and 0.1% ethanol. The control sample was balanced with 0.1% ethanol.

TABLE 4
Formula (1c) in low sodium chicken broth. Sample selected as saltier
by panelists, n = 48 (16 panelists × 3 replicates).

| Samples | Total |
|---|---|
| Low Sodium Chicken Broth | 12 |
| Low Sodium Chicken Broth + | 36 |
| 1 ppm Formula (1c) | |
| Total | 48 |
| Low Sodium Chicken Broth + | 0.001 |
| 1 ppm Formula (1c) selected (p-value) | |

A statistically significant difference was found between the samples; panelists indicated that the test sample containing 1 ppm Formula (1c) was significantly saltier than the control sample (p<0.1).

### Example 1d

### Formula (1d) in Low Sodium Chicken Broth using 2-Alternative Forced Choice

A concentrated stock solution of 8000 ppm of Formula (1d) was prepared in ethanol. The stock solution was added to the low sodium chicken broth to a final concentration of 8 ppm, and 0.1% ethanol. The control sample was balanced with 0.1% ethanol.

TABLE 5
Formula (1d) in low sodium chicken broth. Sample selected as saltier
by panelists, n = 51 (17 panelists × 3 replicates).

| Samples | Total |
|---|---|
| Low Sodium Chicken Broth | 14 |
| Low Sodium Chicken Broth + | 37 |
| 8 ppm Formula (1d) | |
| Total | 51 |
| Low Sodium Chicken Broth + | 0.002 |
| 8 ppm Formula (1d) selected (p-value) | |

A statistically significant difference was found between the samples; panelists indicated that the test sample containing 8 ppm Formula (1d) was significantly saltier than the control sample (p<0.1).

### Example 1e

### Formula (1e) in Low Sodium Chicken Broth using 2-Alternative Forced Choice

A concentrated stock solution of 2000 ppm of Formula (1e) was prepared in ethanol. The stock solution was added to the low sodium chicken broth to a final concentration of 2 ppm, and 0.1% ethanol. The control sample was balanced with 0.1% ethanol.

TABLE 6
Formula (1e) in low sodium chicken broth. Sample selected as saltier
by panelists, n = 51 (17 panelists × 3 replicates).

| Samples | Total |
|---|---|
| Low Sodium Chicken Broth | 19 |
| Low Sodium Chicken Broth + | 32 |
| 2 ppm Formula (1e) | |
| Total | 51 |
| Low Sodium Chicken Broth + | 0.092 |
| 2 ppm Formula (1e) selected (p-value) | |

A statistically significant difference was found between the samples; panelists indicated that the test sample containing 2 ppm Formula (1e) was significantly saltier than the control sample (p<0.1).

### Example 2

### Enhancement of Saltiness Perception in Chicken Broth Using a 2-Alternative Forced Choice Test

Samples of chicken broth were prepared and compared using human taste tests. Control samples contained chicken broth alone. Test samples contained the same chicken broth to which a specific umami compound was added at a specified concentration. To prepare the test sample, a concentrated stock solution of an umami compound was prepared in ethanol. The stock solution was added to a commercially available no-MSG added, low sodium chicken broth (Pacific Organic Free Range Chicken Broth Low Sodium), to which 100 mM NaCl was also added, resulting in a final concentration of the umami compound in the test sample with 0.1% ethanol. To create the control sample, 100 mM NaCl was added to the low sodium chicken broth, and it was balanced with 0.1% ethanol. All samples were served at 55° C.

Trained panelists were used to complete the test with three replicates (subject number reported in Table 1). A 2-Alternative Forced Choice test was used, where panelists received two three-digit blind-coded samples, one control and one test sample, in randomized, counter-balanced order. Panelists tasted samples, rinsing with water between samples, and indicated which of the two samples was saltier. The results were analyzed using a binomial distribution with alpha=0.1.

### Example 2a

### Formula (1a) in Chicken Broth using 2-Alternative Forced Choice

A concentrated stock solution of 2000 ppm of Formula (1a) was prepared in ethanol. The stock solution was added to the low sodium chicken broth to a final concentration of 2 ppm, and 0.1% ethanol. The control sample was balanced with 0.1% ethanol.

TABLE 7
Formula (1a) in chicken broth. Sample selected as saltier by panelists,
n = 48 (16 panelists × 3 replicates).

| Samples | Total |
|---|---|
| Chicken Broth | 17 |
| Chicken Broth + | 31 |
| 2 ppm Formula (1a) | |
| Total | 48 |
| Chicken Broth + | 0.059 |
| 2 ppm Formula (1a) selected (p-value) | |

A statistically significant difference was found between the samples; panelists indicated that the test sample containing 2 ppm Formula (la) was significantly saltier than the control sample (p<0.1).

### Example 2b

### Formula (1c) in Chicken Broth using 2-Alternative Forced Choice

A concentrated stock solution of 1000 ppm of Formula (1c) was prepared in ethanol. The stock solution was added to the low sodium chicken broth to a final concentration of 1 ppm, and 0.1% ethanol. The control sample was balanced with 0.1% ethanol.

TABLE 8
Formula (1c) in chicken broth. Sample selected as saltier by panelists,
n = 51 (17 panelists × 3 replicates).

| Samples | Total |
|---|---|
| Chicken Broth | 18 |
| Chicken Broth + | 33 |
| 1 ppm Formula (1c) | |
| Total | 51 |
| Chicken Broth + | 0.048 |
| 1 ppm Formula (1c) selected (p-value) | |

A statistically significant difference was found between the samples; panelists indicated that the test sample containing 1 ppm Formula (1c) was significantly saltier than the control sample (p<0.1).

### Example 2c

### Formula (1d) in Chicken Broth using 2-Alternative Forced Choice

A concentrated stock solution of 8000 ppm of Formula (1d) was prepared in ethanol. The stock solution was added to the low sodium chicken broth to a final concentration of 8 ppm, and 0.1% ethanol. The control sample was balanced with 0.1% ethanol.

TABLE 9
Formula (1d) in chicken broth. Sample selected as saltier by panelists,
n = 48 (16 panelists × 3 replicates).

| Samples | Total |
|---|---|
| Chicken Broth | 17 |
| Chicken Broth + | 31 |
| 8 ppm Formula (1d) | |
| Total | 48 |
| Chicken Broth + | 0.059 |
| 8 ppm Formula (1d) selected (p-value) | |

A statistically significant difference was found between the samples; panelists indicated that the test sample containing 8 ppm Formula (1d) was significantly saltier than the control sample (p<0.1).

### Example 2d

### Formula (1f) in Chicken Broth using 2-Alternative Forced Choice

A concentrated stock solution of 2000 ppm of Formula (1f) was prepared in ethanol. The stock solution was added to the low sodium chicken broth to a final concentration of 2 ppm, and 0.1% ethanol. The control sample was balanced with 0.1% ethanol.

TABLE 10
Formula (1f) in chicken broth. Sample selected as saltier by panelists,
n = 48 (16 panelists × 3 replicates).

| Samples | Total |
|---|---|
| Chicken Broth | 16 |
| Chicken Broth + | 32 |
| 2 ppm Formula (1f) | |
| Total | 48 |
| Chicken Broth + | 0.029 |
| 2 ppm Formula (1f) selected (p-value) | |

A statistically significant difference was found between the samples; panelists indicated that the test sample containing 2 ppm Formula (1f) was significantly saltier than the control sample (p<0.1).

### Example 3

### Enhancement of Saltiness Perception in Low Sodium Chicken Broth Using a Difference from Reference Test

Samples of low sodium chicken broth were prepared and compared using human taste tests. The reference samples contained low sodium chicken broth alone. The test samples contained the same low sodium chicken broth to which a specific umami compound was added. To prepare the test samples, a concentrated stock solution of an umami compound was prepared in ethanol. The stock solution was added to a commercially available no-MSG added, low sodium chicken broth (Pacific Organic Free Range Chicken Broth Low Sodium), resulting in a final concentration of the umami compound in the test sample with 0.1% ethanol. To create the reference sample, the low sodium chicken broth was balanced with 0.1% ethanol. All samples were served at 55° C.

Trained panelists were used to complete the test with two replicates (subject number reported in each table). A Difference from Reference scaling test was used. Panelists received pairs of samples, consisting of the reference sample and a three-digit blind coded sample, which was either the reference sample again (i.e., a negative control), or the test sample containing the compound of interest. Panelists first tasted the reference sample, then rinsed with water and tasted the blind-coded sample. Panelists were asked to score the test sample for differences in saltiness as compared to the reference sample. Panelists scored the relative saltiness of the test sample on an 11-point numeric line scale, where a score of −5 indicated that the sample was much less salty than the reference sample, 0 indicated that the sample was of equal saltiness to the reference sample, and +5 indicated that the sample was much more salty than the reference sample. The test also included measurement of other attributes rated on separate scales (e.g., umami intensity, bitterness, and chicken flavor) to ensure responses for saltiness focused solely on that attribute. The order in which panelists received sample pairs containing either the reference or the test sample as the three-digit blind coded sample was randomized and counterbalanced.

The results were analyzed using a two-tailed Student's t-test, with alpha=0.1.

### Example 3a

### Formula (1b) in Low Sodium Chicken Broth using Difference from Reference Test

A concentrated stock solution of 5000 ppm of Formula (1b) was prepared in ethanol. The stock solution was added to the low sodium chicken broth to a final concentration of 5 ppm, and 0.1% ethanol. The control sample was balanced with 0.1% ethanol.

TABLE 12
Formula (1b) in low sodium chicken broth. Average
Saltiness Score of Test Sample as compared to Reference
Sample, n = 24 (12 panelists × 2 replicates).

| Blind-coded Sample (compared | Average | Standard | t-Test p-value |
|---|---|---|---|
| to Reference Sample) | Score | Error | (two-tailed) |
| Low Sodium Chicken Broth | 0.1 | 0.2 | 0.059 |
| (Reference) | | | |
| Low Sodium Chicken Broth + | 0.7 | 0.2 | |
| 5 ppm Formula (1b) (Test Sample) | | | |

A statistically significant difference was found between the samples; panelists indicated that the test sample containing 5 ppm Formula (1b) was significantly saltier than the reference sample (p<0.1).

### Example 3b

### Formula (1d) in Low Sodium Chicken Broth using Difference from Reference Test

A concentrated stock solution of 8000 ppm of Formula (1d) was prepared in ethanol. The stock solution was added to the low sodium chicken broth to a final concentration of 8 ppm, and 0.1% ethanol. The control sample was balanced with 0.1% ethanol.

TABLE 12
Formula (1d) in low sodium chicken broth. Average
Saltiness Score of Test Sample as compared to Reference
Sample, n = 30 (15 panelists × 2 replicates).

| Blind-coded Sample (compared | Average | Standard | t-Test p-value |
|---|---|---|---|
| to Reference Sample) | Score | Error | (two-tailed) |
| Low Sodium Chicken Broth | 0.4 | 0.2 | 0.040 |
| (Reference) | | | |
| Low Sodium Chicken Broth + | 0.8 | 0.2 | |
| 8 ppm Formula (1d) (Test Sample) | | | |

A statistically significant difference was found between the samples; panelists indicated that the test sample containing 8 ppm Formula (1d) was significantly saltier than the reference sample (p<0.1).

### Example 3c

### Formula (1e) in Low Sodium Chicken Broth using Difference from Reference Test

A concentrated stock solution of 2000 ppm of Formula (1e) was prepared in ethanol. The stock solution was added to the low sodium chicken broth to a final concentration of 2 ppm, and 0.1% ethanol. The control sample was balanced with 0.1% ethanol.

TABLE 13
Formula (1e) in low sodium chicken broth. Average
Saltiness Score of Test Sample as compared to Reference
Sample, n = 30 (15 panelists × 2 replicates).

| Blind-coded Sample (compared | Average | Standard | t-Test p-value |
|---|---|---|---|
| to Reference Sample) | Score | Error | (two-tailed) |
| Low Sodium Chicken Broth | −0.3 | 0.2 | 0.006 |
| (Reference) | | | |
| Low Sodium Chicken Broth + | 0.5 | 0.2 | |
| 2 ppm Formula (1e) (Test Sample) | | | |

A statistically significant difference was found between the samples; panelists indicated that the test sample containing 2 ppm Formula (1e) was significantly saltier than the reference sample (p<0.1).

### Example 3d

### Formula (1f) in Low Sodium Chicken Broth using Difference from Reference Test

A concentrated stock solution of 2000 ppm of Formula (1f) was prepared in ethanol. The stock solution was added to the low sodium chicken broth to a final concentration of 2 ppm, and 0.1% ethanol. The control sample was balanced with 0.1% ethanol.

TABLE 14
Formula (1f) in low sodium chicken broth. Average
Saltiness Score of Test Sample as compared to Reference
Sample, n = 26 (13 panelists × 2 replicates).

| Blind-coded Sample (compared | Average | Standard | t-Test p-value |
|---|---|---|---|
| to Reference Sample) | Score | Error | (two-tailed) |
| Low Sodium Chicken Broth | 0.4 | 0.2 | 0.091 |
| (Reference) | | | |
| Low Sodium Chicken Broth + | 1.0 | 0.3 | |
| 1 ppm Formula (1f) (Test Sample) | | | |

A statistically significant difference was found between the samples; panelists indicated that the test sample containing 1 ppm Formula (1f) was significantly saltier than the reference sample (p<0.1).

### Example 3e

### Formula (1g) in Low Sodium Chicken Broth using Difference from Reference Test

A concentrated stock solution of 1000 ppm of Formula (1g) was prepared in ethanol. The stock solution was added to the low sodium chicken broth to a final concentration of 1 ppm, and 0.1% ethanol. The control sample was balanced with 0.1% ethanol.

TABLE 15
Formula (1g) in low sodium chicken broth. Average
Saltiness Score of Test Sample as compared to Reference
Sample, n = 30 (15 panelists × 2 replicates).

| Blind-coded Sample (compared | Average | Standard | t-Test p-value |
|---|---|---|---|
| to Reference Sample) | Score | Error | (two-tailed) |
| Low Sodium Chicken Broth | 0.2 | 0.2 | 0.094 |
| (Reference) | | | |
| Low Sodium Chicken Broth + | 0.5 | 0.2 | |
| 1 ppm Formula (1g) (Test Sample) | | | |

A statistically significant difference was found between the samples; panelists indicated that the test sample containing 1 ppm Formula (1g) was significantly saltier than the reference sample (p<0.1).

The foregoing detailed description has been given for clearness of understanding only and no unnecessary limitations should be understood therefrom as modifications will be obvious to those skilled in the art. It is not an admission that any of the information provided herein is prior art or relevant to the presently claimed inventions, or that any publication specifically or implicitly referenced is prior art.

1. A formulation comprising one or more salt-enhancing compounds, wherein the salt-enhancing compound is selected from the group consisting of: 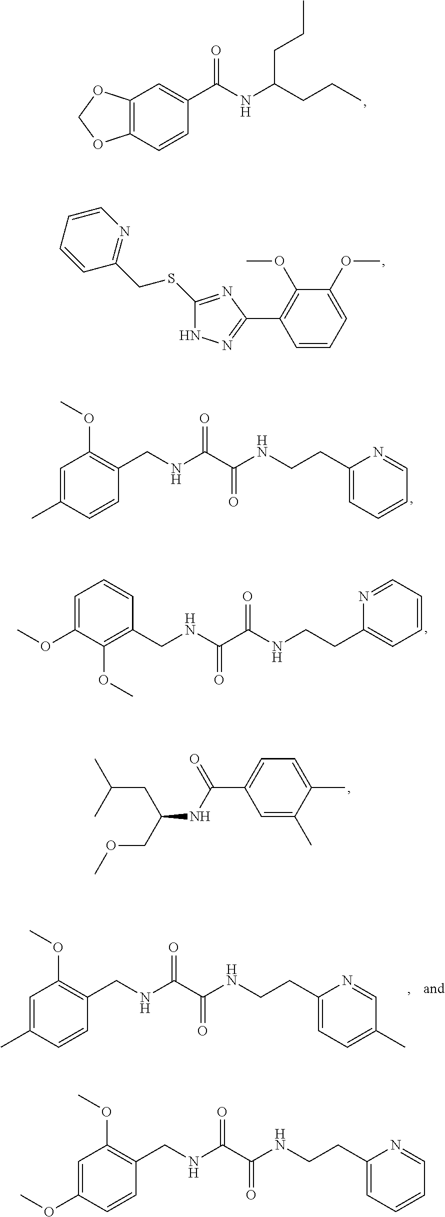
or a salt or solvate thereof.

2. The formulation of claim 1, wherein the formulation comprises less than 900 mg of a chloride salt per serving.

3. (canceled)

4. The formulation of claim 1, wherein the formulation comprises less than 140 mg per serving of a salt selected from sodium chloride, potassium chloride, ammonium chloride, and calcium chloride.

5. The formulation of claim 1, wherein the formulation comprises less than 140 mg of sodium per serving.

6. (canceled)

7. The formulation of claim 1, wherein the formulation comprises less than about 0.1 wt. % of a chloride salt.

8. The formulation of claim 1, wherein the formulation comprises less than about 1 wt. % of sodium.

9. The formulation of claim 8, wherein the formulation comprises less than about 0.08 wt. % of sodium.

10. The formulation of claim 1, which is a comestible composition.

11. The comestible composition of claim 10, which is in the form of a food or beverage product, a pharmaceutical composition, a nutritional product, a dietary supplement, or over-the-counter medication.

12. The comestible composition of claim 10, which is in the form of a food or beverage product for human or animal consumption.

13. The comestible composition of claim 12, wherein the beverage is a broth.

14. The comestible composition of claim 12, wherein the beverage is a cocktail mix.

15. The comestible composition of claim 14, wherein the cocktail mix is a Bloody Mary mix.

16. The comestible composition of claim 10, wherein the composition comprises a fat composition.

17. The comestible composition of claim 12, wherein the food or beverage product is selected from the group consisting of confectioneries, bakery products, dairy products, meal replacement products, soup products, dehydrated and culinary food, frozen food, canned food, snack food, dips, baby food product, oils and fats, and seasonings or seasoning blends.

18. The comestible composition of claim 12, wherein the salt-enhancing compound is present in the modified comestible or medicinal product at a concentration from about 0.01 ppm to about 30 ppm.

19. (canceled)

20. The comestible composition of claim 12, wherein the salt-enhancing compound is present in the modified comestible or medicinal product in a concentration from about 1 ppm to about 8 ppm.

21. A method of modulating the perceived saltiness of a comestible product comprising:
a) providing one or more comestible product; and
b) combining the comestible product with a salty flavor modulating amount of one or more salt-enhancing compounds, wherein the salt-enhancing compound is selected from the group consisting of: 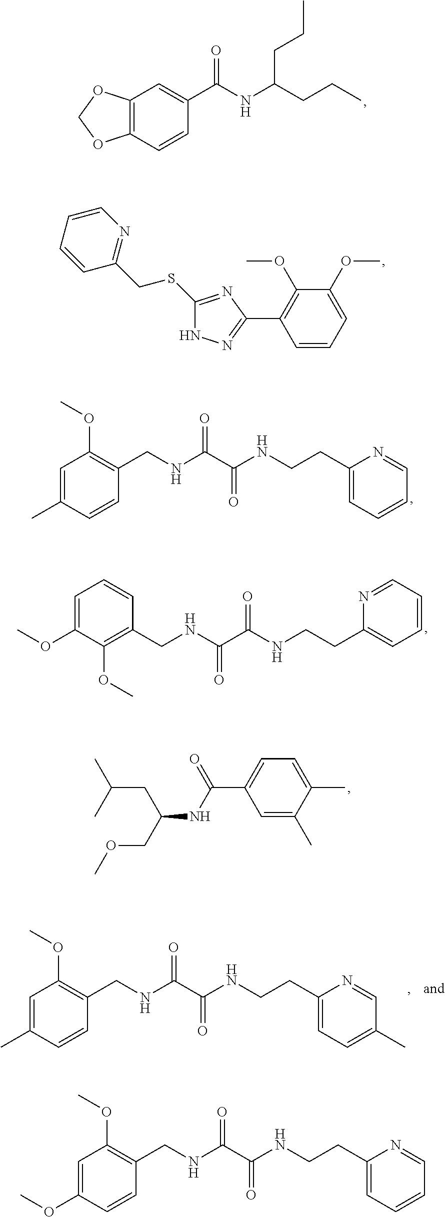
or a salt or solvate thereof.

22. The method of claim 21, wherein the modified comestible or medicinal product is a composition for human or animal consumption.

23. The method of claim 21, wherein the one or more comestible product comprises less than 900 mg of a chloride salt per serving.

24. (canceled)

25. The method of claim 21, wherein the one or more comestible product comprises less than 140 mg per serving of a salt selected from sodium chloride, potassium chloride, ammonium chloride, calcium chloride, and monosodium glutamate.

26. The method of claim 21, wherein the one or more comestible product comprises less than 140 mg of sodium per serving.

27. The method of claim 21, wherein the modified comestible or medicinal product is a food, beverage, or oral hygiene product.

28. The method of claim 27, wherein the food or beverage product is selected from the group consisting of confectioneries, bakery products, dairy products, meal replacement products, soup products, dehydrated and culinary food, frozen food, canned food, snack food, dips, baby food product, oils and fats, and seasonings or seasoning blends.

29. (canceled)

30. The method of claim 21, wherein the salt-enhancing compound is present in the modified comestible or medicinal product at a concentration from about 0.01 ppm to about 30 ppm.

31. (canceled)

32. The method of claim 21, wherein the salt-enhancing compound is present in the modified comestible or medicinal product in a concentration from about 1 ppm to about 8 ppm.
